(19) United States
(12) Patent Application Publication
(10) Pub. No.: US 2007/0020397 A1
(43) Pub. Date: Jan. 25, 2007

(54) Method of fabricating printed circuit board using imprinting process

(75) Inventors: Jae Choon Cho, Gyeonggi-do (KR); Myeong Ho Hong, Gyeonggi-do (KR); Seung Hyun Ra, Gyeonggi-do (KR); Il Sang Maeng, Gyeonggi-do (KR); Jeong Bok Kwak, Gyeonggi-do (KR); Choon Keun Lee, Gyeonggi-do (KR); Sang Moon Lee, Seoul (KR)

Correspondence Address: GOTTLIEB RACKMAN & REISMAN PC, 270 MADISON AVENUE, 8TH FLOOR, NEW YORK, NY, 100160601, US

(73) Assignee: SAMSUNG ELECTRO-MECHANICS CO., LTD.

(21) Appl. No.: 11/435,429

(22) Filed: May 16, 2006

(30) Foreign Application Priority Data
Jul. 22, 2005 (KR) 10-2005-0066802

(51) Int. Cl. B05D 3/12; C25D 5/02

(52) U.S. Cl. 427/355; 205/125; 205/222; 205/223

(57) ABSTRACT

Disclosed herein is a method of fabricating a printed circuit board using an imprinting process, including forming a plating layer on an insulating layer having a plurality of recessed patterns formed through an imprinting process, and etching and polishing the portion of the plating layer using an etchant, resulting in a low polishing process cost and eliminating the need for an additional polishing process, because deterioration of the surface of the insulting layer is prevented.

### BACKGROUND OF THE INVENTION

1. Field of the Invention

The present invention relates, generally, to a method of fabricating a printed circuit board (PCB) using an imprinting process, and more particularly, to a method of fabricating a PCB using an imprinting process, in which a plating layer is removed from the surface of an insulating layer through etching and polishing using an etchant at the time of the surface polishing.

2. Description of the Related Art

According to recent trend toward the fabrication of light, slim, short and small electronic products to be miniaturized, made thin, highly dense, packaged and personally portable, miniaturization and packaging of a PCB are also required. Thus, with the goal of increasing the reliability and design density of the PCB, the composite layer structure of a circuit, as well as the change of materials for PCBs, should be realized. In addition, while electronic parts change from a DIP (Dual In-line Package) type to an SMT (Surface Mount Technology) type, mounting densities thereof are increasing. In addition, designs for PCBs are becoming complicated, with the need for considerably difficult techniques, due to the portability and high functionality of electronic devices and the necessity for sending/receiving large amounts of data, such as Internet data and moving images, through the electronic devices.

For small and highly dense PCBs, a fine circuit pattern must be realized above all. That is, the demand for a highly dense substrate is increasing, and thus, line/space requirements for a circuit pattern are becoming increasingly fine.

Generally, methods of fabricating a PCB comprise a photolithographic process that is advantageous in terms of having high productivity and a low fabrication cost. However, in the case where the circuit pattern is formed to have a line/space of not more than 10 μm/10 μm, a lateral etching phenomenon, in which the circuit pattern is excessively etched, occurs upon the removal of electroless plated conductive material, leading to defects such as short circuits or delamination. Consequently, limitations are imposed on the realization of fine circuit patterns.

In order to solve such problems, a method of fabricating a PCB using an imprinting process has been proposed.

FIGS. 1A to 1E show a conventional process of fabricating a PCB using an imprinting process, which is disclosed in Japanese Patent Laid-open Publication No. 2004-152934.

As shown in FIG. 1A, a mold 1 having protrusions 2 corresponding to a conductive circuit is provided.

As shown in FIG. 1B, epoxy resin is laminated on the mold 1, to which heat and pressure are then applied, and thus, as shown in FIG. 1C, an insulating substrate 3 having recesses 4 is formed.

As shown in FIG. 1D, a conductive paste 5 is printed on the insulating substrate 3 using an ink-jetting process, and is then cured.

As shown in FIG. 1E, the surface printed with the conductive paste 5 is polished to remove the conductive paste provided at portions other than the recesses 4 of the insulating substrate 3, thus completing a PCT.

In such a case, a CMP (Chemical Mechanical Polishing) process, in which slurry is supplied to a platen polishing machine, is adopted as the surface polishing process.

The CMP process is a polishing technique comprising a combination of a chemical reaction and mechanical polishing to planarize a metal plug using a slurry comprising a mixture of solid abrasive material, a liquid oxidant, and water. The polishing machine is composed of a carrier for holding a substrate to be polished, a polishing table provided with a polishing pad, and a slurry feeder for supplying a polishing slurry. According to the CMP process, the surface of the substrate is polished through the motion of the polishing pad relative to the substrate while supplying the slurry, acting as fluid having chemical reactivity, between the substrate and the pad. That is, the surface of the substrate is polished in a manner such that a predetermined layer formed on the surface of the substrate due to the reaction with the slurry is removed by abrasive particles pressed through the motion of the polishing pad relative to the substrate.

In the method of fabricating a PCB using an imprinting process described above, since the CMP process is used for surface polishing, investment costs for equipment, as well as expenses for process maintenance and consumable parts, are excessively increased, leading to a high product price.

Further, when the CMP process is conducted for surface polishing, a deterioration layer may be undesirably formed on the surface of the substrate, and thus an additional process for removing such a deterioration layer is further required.

That is, the deterioration layer, resulting from the dislocation of the surface layer of the substrate in the direction of the polishing pad due to the use of the polishing pad upon the CMP process, requires an additional polishing process to remove it.

### SUMMARY OF THE INVENTION

In order to solve the problems encountered in the prior art, an object of the present invention is to provide a method of fabricating a PCB using an imprinting process, in which an inexpensive surface polishing process is conducted, thus increasing the price competitiveness of products.

Another object of the present invention is to provide a method of fabricating a PCB using an imprinting process, in which a surface polishing process is conducted without the need for an additional polishing process, thus minimizing the number of processes.

In order to accomplish the above objects, the present invention provides a method of fabricating a PCB using an imprinting process, comprising steps of (A) forming a plating layer on an insulating layer having a plurality of recessed patterns formed through an imprinting process, and (B) etching and polishing a portion of the plating layer to expose the surface of the insulting layer other than the plurality of recessed patterns.

According to the method of fabricating a PCB using an imprinting process of the present invention, the step (A) may comprise (A-1) providing a stamper having a plurality of raised patterns, (A-2) placing the stamper on the insulating layer, heat pressing the stamper and the insulating layer, and removing the stamper from the insulating layer, to form the plurality of recessed patterns in the insulating layer, corresponding to the plurality of raised patterns on the stamper, and (A-3) forming the plating layer on the insulating layer to be loaded in the plurality of recessed patterns of the insulating layer.

According to the method of fabricating a PCB using an imprinting process of the present invention, the plurality of recessed patterns of the insulating layer may comprise a circuit pattern and a via hole.

According to the method of fabricating a PCB using an imprinting process of the present invention, the insulating layer may comprise a thermosetting resin.

According to the method of fabricating a PCB using an imprinting process of the present invention, the plating layer may be formed through electroless copper plating and copper electroplating.

According to the method of fabricating a PCB using an imprinting process of the present invention, the etching and polishing may be conducted using any one etchant selected from among copper chloride, iron chloride, an alkali etchant, and an acid etchant.

### BRIEF DESCRIPTION OF THE DRAWINGS

FIGS. 1A to 1E are cross-sectional views showing a conventional process of fabricating a PCB using an imprinting process;

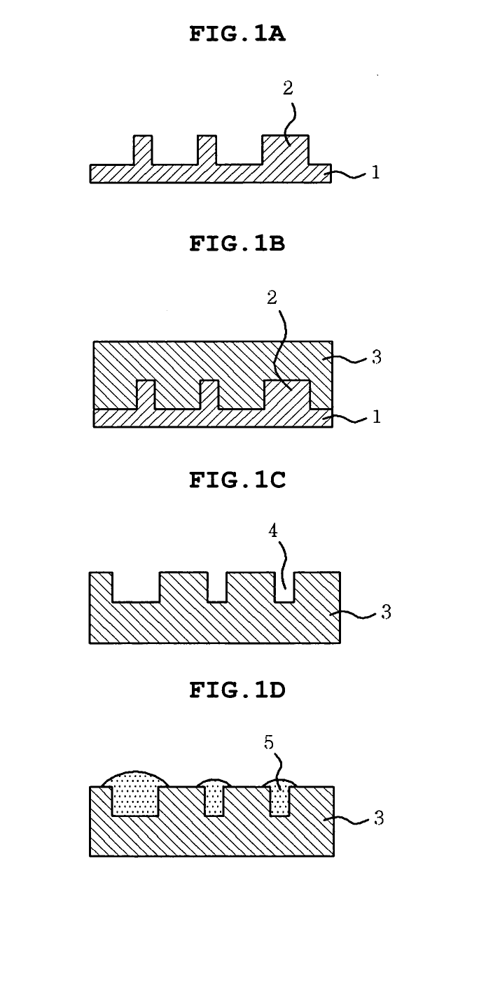

FIG. 2 is a flowchart showing a process of fabricating a PCB using an imprinting process according to the present invention; and

FIGS. 3A to 3E are cross-sectional views showing the process of fabricating a PCB using an imprinting process according to the present invention.

### DESCRIPTION OF THE PREFERRED EMBODIMENT

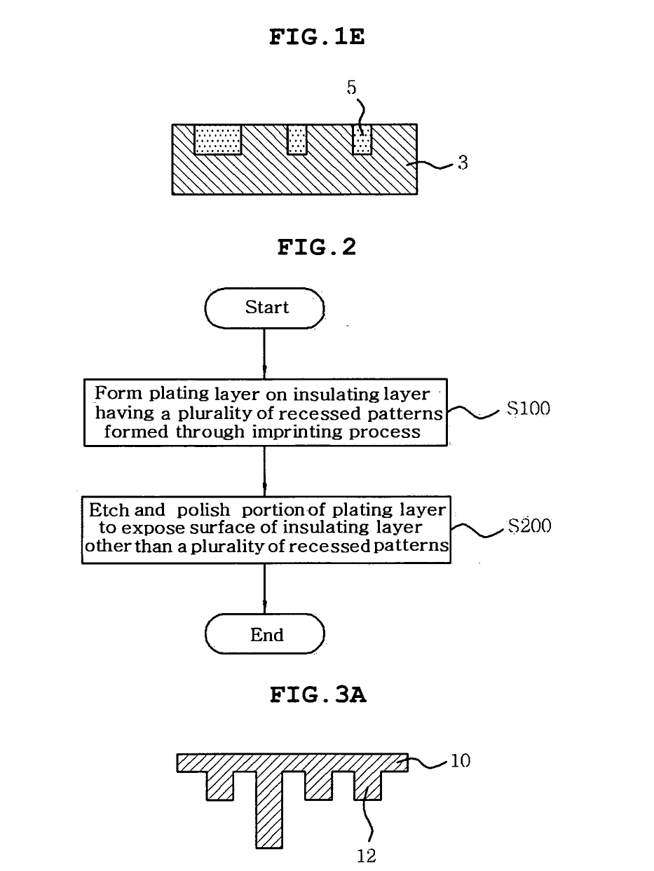

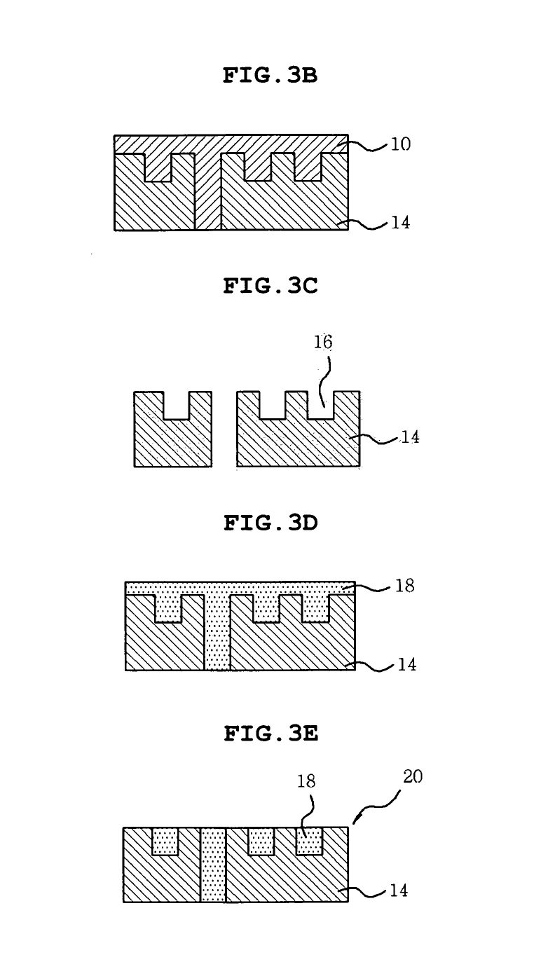

Hereinafter, a detailed description will be given of the preferred embodiment of the present invention in conjunction with FIGS. 2 and 3.

FIG. 2 is a flowchart showing a process of fabricating a PCB using an imprinting process according to the present invention, and FIGS. 3A to 3E are cross-sectional views showing the process of fabricating a PCB using an imprinting process according to the present invention.

Referring to FIG. 2, the process of fabricating a PCB using an imprinting process according to the present invention is described.

First, a plating layer is formed on an insulating layer having a plurality of recessed patterns formed through an imprinting process (S100).

To this end, a stamper having a plurality of raised patterns is placed on the insulating layer, after which it is heat pressed to form the insulating layer having the plurality of recessed patterns corresponding to the plurality of raised patterns of the stamper. Subsequently, electroless copper plating and copper electroplating are conducted on the insulting layer, thus forming the plating layer.

The plurality of recessed patterns of the insulating layer includes a circuit pattern and a via hole.

Thereafter, a portion of the plating layer is etched and polished to expose the surface of the insulating layer other than the plurality of recessed patterns (S200).

That is, since the plating layer is formed on the surface of the insulating layer while being loaded in the plurality of recessed patterns of the insulating layer, the plating layer formed on the surface of the insulating layer other than the plurality of recessed patterns is subjected to surface polishing through an etching process to remove it, thus fabricating the PCB using an imprinting process.

The etching and polishing process may be conducted using an etchant, such as copper chloride, iron chloride, an alkali etchant, and an acid etchant.

Turning now to FIGS. 3A to 3E, the method of fabricating a PCB using an imprinting process according to the present invention is specifically explained.

As shown in FIG. 3A, a stamper 10 having a plurality of raised patterns 12 is provided.

The stamper 10 having the plurality of raised patterns 12 may be formed through a molding process or a surface process using a material such as a metal, SiO₂, or a polymer.

The surface process for processing one surface of a predetermined substrate is exemplified by electron beam lithography, photolithography, dicing, laser cutting, and RIE (Reactive Ion Etching).

Alternatively, the stamper 10 may be formed by separately preparing patterns and attaching them to a predetermined stamper substrate.

The plurality of raised patterns 12 of the stamper 10 is formed to have a circuit pattern and a via hole.

As shown in FIG. 3B, the stamper 10 is placed on an insulating layer 14, and is then heat pressed. As shown in FIG. 3C, the stamper 10 is removed, thereby forming the plurality of recessed patterns 16 in the insulating layer, corresponding to the plurality of raised patterns 12 on the stamper 10.

The insulating layer 14 is formed of a polymer material having a glass transition temperature lower than the glass transition temperature of the stamper 10.

Upon heat pressing, heat lower than the glass transition temperature of the stamper 10 and higher than the glass transition temperature of the insulating layer 14 is applied, such that the plurality of recessed patterns 16 corresponding to the plurality of raised patterns 12 of the stamper 10 is formed in the insulating layer 14 while maintaining the shape of the plurality of raised patterns 12 thereof.

The method of fabricating a PCB using an imprinting process according to the present invention further comprises desmearing the plurality of recessed patterns 16 formed in the insulating layer 14 to increase bondability and surface adhesion to the plating layer to be subsequently formed.

That is, the desmearing process is used to remove smear attached to the inner wall of the plurality of recessed patterns 16 by the insulating material melted due to friction heat generated when heat pressing the stamper 10 to the insulating layer 14 and removing the stamper 10 therefrom, so as to increase plating adhesion and bondability to the plating layer.

The desmearing process may be conducted through a high-pressure washer or a chemical reaction using manganese peroxide.

Then, as shown in FIG. 3D, a plating layer 18 is formed on the insulating layer 14.

As such, the plating layer 18 is formed through electroless copper plating and copper electroplating.

Since the copper electroplating process through electrolysis cannot be conducted on the insulating layer 14, the electroless copper plating process, acting as a chemical copper plating process, is first performed, and then the copper electroplating process proceeds, thus forming the plating layer 18. Further, the electroless copper plating process, which suffers because it is difficult to use to form a thick plating film and results in properties inferior to the copper electroplating process, is preferably carried out along with the copper electroplating process.

The electroless copper plating process is performed through deposition, in which a metal to be plated is reduced using a plating solution containing a reducing agent. For example, the deposition includes a series of procedures of cleaning, soft-etching, pre-catalysis, catalysis, acceleration, electroless copper plating, and oxidation prevention.

After the completion of the electroless copper plating process, the copper electroplating process is conducted in a manner such that the metal ion receives an electron and is thus deposited into metal at a cathode while the metal loses an electron and is thus converted into the metal ion at an anode, through the application of external direct current. The plating area is calculated and therefore a predetermined current required to plate the calculated plating area is applied using the DC rectifier.

As shown in FIG. 3E, the plating layer 18 formed on the surface of the insulating layer 14 other than the plurality of recessed patterns 16 is etched and polished, thus providing the PCB 20 using an imprinting process.

Through the etching and polishing process, the portion of the plating layer 18, which is as thick as the plating layer 18 formed on the surface of the insulating layer 14 other than the plurality of recessed patterns 16, is removed using an etchant. Thereby, the plurality of recessed patterns 16 of the insulating layer 14 is filled with the plating layer 18, and the surface of the insulating layer 14 other than the plurality of recessed patterns 16 is exposed.

The plurality of recessed patterns 16 filled with the plating layer 18 has a circuit pattern and a via hole.

Preferably, the etching and polishing process may be conducted to further remove a predetermined thickness in addition to the thickness of the plating layer 18 formed on the surface of the insulating layer 14 other than the plurality of recessed patterns 16, so as to assure good surface flatness.

As such, the predetermined thickness preferably corresponds to 0˜10% of the thickness of the insulating layer.

Examples of the etchant include copper chloride (CuCl₂), iron chloride (FeCl₃), an alkali etchant, and a hydrogen peroxide/sulfuric acid (H₂O₂/H₂SO₄) etchant.

The copper chloride (CuCl₂) etchant functions to assure stable etching upon use along with an additive such as HCl or NH₄Cl. Further, uniform composition of this etchant is easy to maintain through a reproduction reaction, leading to precise etching.

The iron chloride (FeCl₃) etchant has a relatively high etching speed and is inexpensive, and thus has wide applicability. However, this etchant suffers because the surface of an etching machine is contaminated with a purplish brown color due to iron hydroxide produced by a chemical reaction, and thus is not cleaned even when washed with water.

The alkali etchant is suitable for highly precise etching and has a longer lifetime and higher etching speed than other etchants. In addition, etching material species are highly varied, including, for example, solder, gold, silver, nickel, rhodium, tin, lead-nickel alloy, etc. This etchant is favorable in terms of the prevention of pollution.

The hydrogen peroxide/sulfuric acid (H₂O₂/H₂SO₄) etchant includes appropriate amounts of a stabilizer, a catalyst, and an inhibitor, and thus has high etching efficiency and excellent stability. This etchant is advantageous because etched copper is recovered as copper sulfate, and therefore a closed etching system in which the etchant may be semi-permanently used is realized, but is disadvantageous because the etchant is expensive.

The method of fabricating a PCB using an imprinting process according to the present invention adopts the etching and polishing process using the etchant upon surface polishing for removing the plating layer 18 formed on the surface of the insulating layer 14 other than the plurality of recessed patterns 16. Thereby, the surface polishing process used in the present invention may be conducted more inexpensively than a conventional surface polishing process such as CMP, and thus price competitiveness of a product can be increased.

Moreover, the etching and polishing process of the present invention functions to selectively etch only the plating layer formed on the surface of the insulating layer 14. Hence, even though an additional polishing process is not conducted, the surface of the insulating layer 14 can be maintained in a state of high flatness without deterioration.

As described hereinbefore, the present invention provides a method of fabricating a PCB using an imprinting process. According to the method of the present invention, upon surface polishing, an etching and polishing process using an etchant is conducted, thereby decreasing the cost of the polishing process, leading to increased price competitiveness of products.

In addition, according to the method of the present invention, since the etching and polishing process functions to selectively remove only a plating layer formed on the surface of an insulating layer, the surface of the insulating layer does not deteriorate, thus obtaining a PCB having high surface flatness without the need for an additional polishing process.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method of fabricating a printed circuit board using an imprinting process, comprising steps of:
(A) forming a plating layer on an insulating layer having a plurality of recessed patterns formed through an imprinting process; and
(B) etching and polishing a portion of the plating layer to expose a surface of the insulting layer other than the plurality of recessed patterns.

2. The method as set forth in claim 1, wherein step (A) comprises:
(A-1) providing a stamper having a plurality of raised patterns;
(A-2) placing the stamper on the insulating layer, heat pressing the stamper and the insulating layer, and removing the stamper from the insulating layer, to form the plurality of recessed patterns in the insulating layer, corresponding to the plurality of raised patterns on the stamper; and
(A-3) forming the plating layer on the insulating layer to be loaded in the plurality of recessed patterns of the insulating layer.

3. The method as set forth in claim 1, wherein the plurality of recessed patterns of the insulating layer includes a circuit pattern and a via hole.

4. The method as set forth in claim 1, wherein the insulating layer comprises a thermosetting resin.

5. The method as set forth in claim 1, wherein the plating layer is formed through electroless copper plating and copper electroplating.

6. The method as set forth in claim 1, wherein the etching and polishing are conducted using any one etchant selected from among copper chloride, iron chloride, an alkali etchant, and an acid etchant.
